(19) United States
(12) Patent Application Publication
(10) Pub. No.: US 2022/0063281 A1
(43) Pub. Date: Mar. 3, 2022

(54) INKJET RECORDING APPARATUS

(71) Applicant: Konica Minolta, Inc., Tokyo (JP)

(72) Inventors: Hiroshige KIDERA, Tokyo (JP); Naoki TOYOSHI, Toyohashi-shi (JP)

(21) Appl. No.: 17/462,539

(22) Filed: Aug. 31, 2021

(30) Foreign Application Priority Data
Aug. 31, 2020 (JP) 2020-145934

(51) Int. Cl. B41J 2/165; B41J 2/045

(52) U.S. Cl. CPC B41J 2/16535; B41J 2002/16573; B41J 2/0451; B41J 2/04553

(57) ABSTRACT

An inkjet recording apparatus includes an inkjet head that ejects ink from a nozzle and records an image; a wiping and cleaning mechanism that wipes a nozzle surface with a cleaning member, the inkjet head has the nozzle surface at which an ejection port of the nozzle of is formed; and a hardware processor that controls operation including the recording operation. the hardware processor performs dry maintenance control in which dry wiping using the wiping and cleaning mechanism is controlled, and wet maintenance control in which wet wiping using the wiping and cleaning mechanism and including wetting at least a part of a wiping surface of the cleaning member is controlled.

### CROSS-REFERENCE TO RELATED APPLICATIONS

The present invention claims priority under 35 U.S.C. § 119 to Japanese Patent Application No. 2020-145934 filed on Aug. 31, 2020, the entire content of which is incorporated herein by reference.

### BACKGROUND

### Technological Field

The present invention relates to an inkjet recording apparatus.

### Description of Related Art

A conventional inkjet recording apparatus records images by ejecting ink from nozzle(s) of an inkjet head and depositing the ink on a desired position on a recording medium. When ink adheres to nozzle surfaces of the inkjet head (the surfaces on which the nozzle's ejection ports are formed), the adhered ink solidifies and partially blocks the nozzle's ejection ports, clogging the nozzles and causing ink ejection failure.

In AN inkjet recording apparatus, when the nozzles become clogged, the nozzle surfaces are usually wiped with a cleaning material to remove the clogging.

In the invention described in JP H03-222754 A, it is proposed to remove nozzle clogging and the like by changing the pressure for dry wiping depending on accumulated dirt on the nozzle surfaces.

When cleaning the nozzle clogging and the like by changing the pressure to high pressure in a dry wiping state as described in JP H03-222754 A, problems may occur such as scratching of the nozzle surfaces and accelerated deterioration of the durability of the nozzle surfaces.

On the other hand, wet wiping that involves wetting the nozzle surfaces and then cleaning them provides a higher cleaning performance than the dry wiping. However, the wet wiping has disadvantages such as the need of a mechanism to wet a non-woven fabric, which results in enlargement of the apparatus. Furthermore, when a cleaning mechanism of the nozzle surfaces for the wet wiping is separately installed in addition to the cleaning mechanism of the nozzle surfaces for the dry wiping, the apparatus will become even larger.

### SUMMARY

The present invention was made in consideration of the problems that occur in the conventional technology described above, and the purpose of the present invention is to effectively clean the nozzle surface(s) of an inkjet recording apparatus having a cleaning mechanism for dry wiping of the nozzle surfaces of the inkjet head, and to recover ink ejection performance by wet wiping of the nozzle surface(s) when and where necessary, while avoiding increasing the size of the apparatus.

To achieve at least one of the above-mentioned objects, an inkjet recording apparatus reflecting one aspect of the present invention includes:

an inkjet head that ejects ink from a nozzle and records an image;

a wiping and cleaning mechanism that wipes a nozzle surface with a cleaning member, the inkjet head has the nozzle surface at which an ejection port of the nozzle of is formed; and

a hardware processor that controls operation including the recording operation; wherein

the hardware processor performs dry maintenance control in which dry wiping using the wiping and cleaning mechanism is controlled, and wet maintenance control in which wet wiping using the wiping and cleaning mechanism and including wetting at least a part of a wiping surface of the cleaning member is controlled.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 is a block diagram showing a functional configuration of an inkjet recording apparatus according to an embodiment of the present invention;

FIG. 2 is a schematic diagram of a side view showing a main configuration of the inkjet recording apparatus according to the embodiment of the present invention;

FIG. 3 is a schematic diagram of a side view showing a main configuration of the inkjet recording apparatus according to the embodiment of the present invention;

FIG. 4 is a plan view showing an arrangement of a nozzle surface and a cleaning member of the inkjet recording apparatus according to an embodiment of the present invention;

FIG. 5 is a graph of torque recorded or estimated by a controller corresponding to a number of ejections according to an embodiment of the present invention;

FIG. 6 is a flowchart showing an example of control that includes maintenance control in an inkjet recording apparatus according to an embodiment of the present invention; and

FIG. 7 is a graph showing a relationship between detected torque and an amount of supplied liquid in an inkjet recording apparatus according to an embodiment of the present invention.

### DETAILED DESCRIPTION OF THE EMBODIMENTS

Hereinafter, one or more embodiments of the present invention will be described with reference to the drawings. However, the scope of the invention is not limited to the illustrated examples.

### [Outline of Inkjet Recording Apparatus]

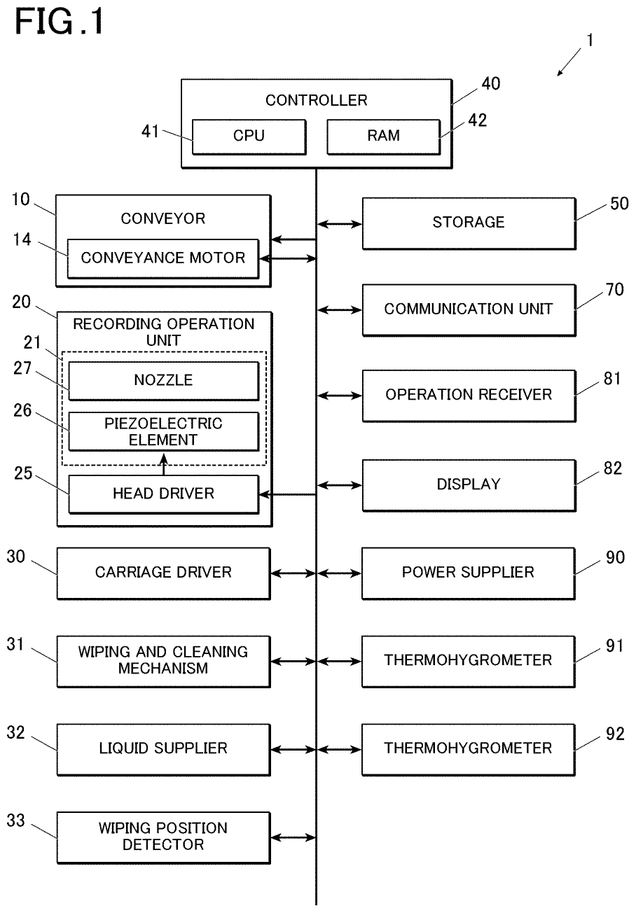

As shown in FIG. 1 to FIG. 3, the inkjet recording apparatus 1 includes a conveyor 10, a recording operation unit 20, a carriage driver 30, a wiping and cleaning mechanism 31, a liquid supplier 32, a wiping position detector 33, a controller 40 (hardware processor), a storage 50, a communication unit 70, a operation receiver 81, a display 82, a power supplier 90, thermohygrometers 91, 92, and the like.

The conveyor 10 moves a recording medium, which is the target of image recording, so as to face the range of recording by the recording operation unit 20. For example, the conveyor 10 includes a conveyance drum that supports the recording medium, and a conveyance motor 14 that drives the conveyance roller to rotate. The recording medium is, for example, a fabric, but may be other materials such as paper.

The recording operation unit 20 performs the recording operation to record images by ejecting ink onto the recording medium. The recording operation unit 20 includes an inkjet head 21 having a number of nozzles 27 arranged in a predetermined pattern and ejecting ink from the ejection port 27a and piezoelectric elements 26 deforming an ink flow path (pressure chamber) that supplies ink to the nozzles 27 and causes pressure changes in the ink, a head driver 25 outputting a drive pulse voltage to deform each piezoelectric element 26, and the like.

The carriage driver 30 corresponds to a drive circuit for a power motor that moves the carriage 2. The carriage 2 is provided with an inkjet head 21 and can be moved by the drive power output from the carriage driver 30 in accordance with the control by the controller 40.

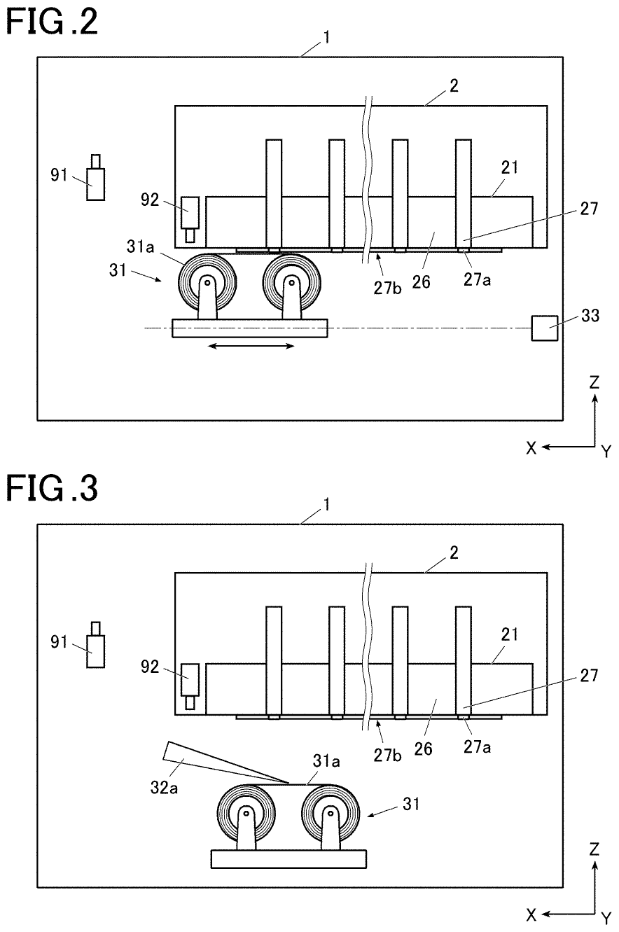

As shown in FIG. 2 and FIG. 3, the wiping and cleaning mechanism 31 includes a winding mechanism that winds up a cloth 31a as a cleaning member and renews the portion of the cloth 31a in contact with the nozzle surface 27b. The wiping and cleaning mechanism 31 is supported by a moving mechanism that moves horizontally and vertically, and moves relative to the inkjet head 21 in the X direction so as to wipe the nozzle surface 27b on which the ejection port 27a of the inkjet head 21 is formed.

The liquid supplier 32 is a device that supplies liquid (water or other washing liquid) for wet wiping by dropping it onto the cloth 31a.

A liquid dispenser 32a shown in FIG. 3 is the tip of the liquid supplier 32 or a dropper (or pipette) operated by a user.

The wiping position detector 33 obtains positional coordinate information on the cleaning member in a wiping direction X. The wiping position detector 33 may include a rotary encoder provided in a movement mechanism of the wiping and cleaning mechanism 31 in the X direction, a distance measuring sensor that measures the distance of the wiping and cleaning mechanism 31 in the X direction, or the like.

The operation receiver 81 receives the user's operation and outputs it to the controller 40. The operation receiver 81 has, for example, a touch sensor. The touch sensor may be provided on a display screen of the display 82 to constitute a touch panel display together with the display 82. The operation receiver 81 outputs information on position and type of touching operation detected by the touch sensor to the controller 40. The operation receiver 81 may also have pushbutton switches and/or numeric keys.

The display 82 displays the status of the inkjet recording apparatus 1, operation menus, and the like on the display screen in accordance with a control signal from the controller 40. The display screen may be, for example, a liquid crystal screen. The display 82 may also include a speaker or the like for audio output.

The thermohygrometer 91 measures temperature and humidity of the environment in which the inkjet recording apparatus 1 is placed, and is located far enough away from the inkjet head 21 and the wiping and cleaning mechanism 31 such that the influence of the liquid for wet wiping can be ignored.

The thermohygrometer 92 measures temperature and humidity in a vicinity of the inkjet head 21. The thermohygrometer 92 is located next to the nozzle surface 27b to obtain measurement values affected by dry/wet conditions of the inkjet head 21, and is oriented such that the main area to be measured is a space below the lower surface of the head 21 where the nozzle surface 27b faces.

The controller 40 is a processor (control device) that controls the overall operation of the inkjet recording apparatus 1, including the recording operation. The controller 40 includes, for example, a CPU (Central Processing Unit) 41, a RAM (Random Access Memory) 42, and other components. The CPU 41 performs arithmetic operations and performs various control processes. The RAM 42 provides the CPU 41 with a memory space for work and stores temporary data.

The storage 50 stores image data to be recorded and processing data therefor, and also stores other setting data and programs. The image data may be stored, for example, in a DRAM that can temporarily store a large amount of data for high-speed output. The setting data, programs, and the like are stored in a non-volatile memory such as a flash memory and/or a HDD (Hard Disk Drive) in which data can be stored even when the power supply to the inkjet recording apparatus 1 is stopped.

The communication unit 70 controls transmitting and receiving data to and from external devices in accordance with a predetermined communication standard (for example, TCP/IP (Transmission Control Protocol/Internet Protocol)). The communication unit 70 is connected to a LAN (Local Area Network) or the like, and may be connected to the external Internet via a router or the like, or may be directly connected to a peripheral device via a USB cable connected to a USB terminal.

The power supplier 90 supplies power to the inkjet recording apparatus 1 from a power source.

### [Details of Maintenance Control]

Next, the details of dry maintenance control and wet maintenance control by the controller 40 will be explained.

The controller 40 executes dry maintenance control, which controls dry wiping using the wiping and cleaning mechanism 31 in accordance with a predetermined condition(s). The predetermined condition here includes a regular or quantitative condition, and is defined by the recording operation amount. In this embodiment, the predetermined condition is defined by the number of ejections, but other parameters such as drive time, ink ejection amount, number of printed pages, and the like may also be used.

During the dry maintenance control and the wet maintenance control, the controller 40 controls the position of the wiping and cleaning mechanism 31 to press the cloth 31a against the nozzle surface 27b, and then wipes the nozzle surface 27b by moving the wiping and cleaning mechanism 31 relative to the inkjet head 21 in the X direction (wiping operation). The wiping and cleaning mechanism 31 may be operated so as to perform wiping not only by relative movement in the X direction but also by reciprocating movement in the Y direction in the drawings.

During the wiping, a torque value of the motor that causes the relative movement of the inkjet head 21 and the wiping and cleaning mechanism 31 is detected. The detected value of this torque is input to the controller 40.

The controller 40 obtains the detected torque value in the dry maintenance control as an index value of wiping resistance of the dry wiping in the dry maintenance control in order to recognize the dry wiping situation. Also, controller 40 obtains the torque detection value during the wet maintenance control in order to determine abnormalities and the like during the wet wiping.

One way to detect torque is to measure the current of the DC motor used in the above driving. Another way to detect torque is to use the motor's signal if a brushless motor is used for the above drive, since the brushless motor will step out due to increased torque.

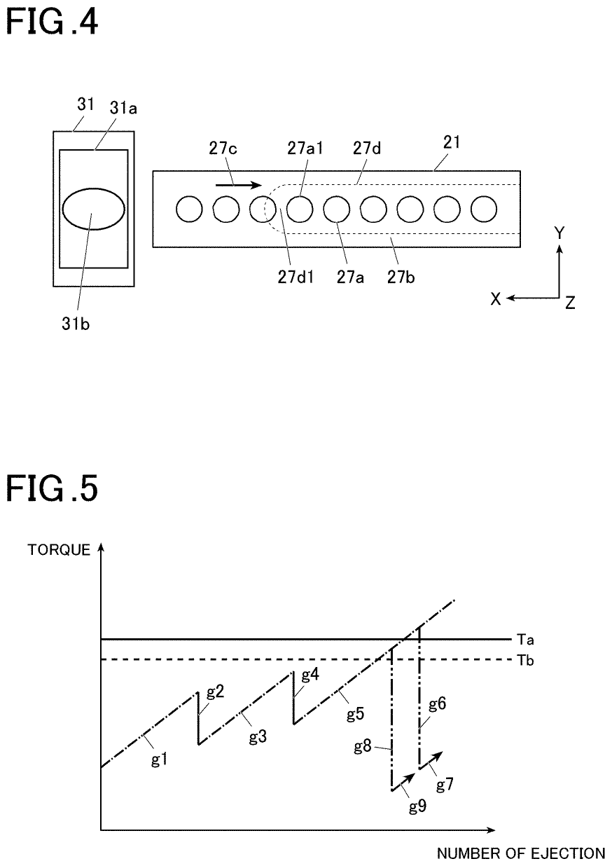

The controller 40 performs the wet maintenance control in accordance with predetermined condition(s) by using the wiping and cleaning mechanism 31 and controlling the wet wiping including wetting of a part 31b of the wiping surface of the cloth 31a as shown in FIG. 4. At this time, as shown in FIG. 4, the part 31b of the cloth 31a to be wetted includes a part in contact with the ejection port 27a of the nozzle 27 during the wiping. As a result, the ejection port 27a of the nozzle 27 and its surrounding area are effectively cleaned by the wet wiping, and the ejecting performance is recovered.

According to an example, the controller 40 instructs the user via the display 82 to wet a part of the wiping surface of the cloth 31a in the wet maintenance control. At this time, the controller 40 positions the wiping and cleaning mechanism 31 away from the inkjet head 21 as shown in FIG. 3, so that liquid can be dropped from an dropper or the like onto the cloth 31a. The position to be wetted by the dropping is guided to be the part 31b in FIG. 4. The user drops the liquid on the cloth 31a and inputs an indication to the operation receiver 81 that the drop has been completed. This causes a part of the wiping surface of the cloth 31a to become wet, and the controller 40 wipes the nozzle surface 27b with the cloth 31a in a wet condition. In this example method, the liquid supplier 32 does not have to be equipped.

According to another example, the controller 40 instructs the liquid supplier 32 to wet a part of the wiping surface of the cloth 31a in the wet maintenance control. As shown in FIG. 3, the controller 40 controls the positions of the wiping and cleaning mechanism, the inkjet head 21, and the liquid dispenser 32a of the liquid supplier 32 and causes the liquid supplier 32 to drop liquid on the wiping surface of the cloth 31a. The part 31b in FIG. 4 is controlled so as to be wetted by the dropping. This causes a part of the wiping surface of the cloth 31a to become wet, and the controller 40 wipes the nozzle surface 27b with the cloth 31a in a wet condition.

FIG. 5 is a graph showing the correspondence between the torque recorded or estimated by the controller 40 and the number of ejections.

The controller 40 records the detected torque values (g2, g4) corresponding to the number of ejections.

The controller 40 performs the dry maintenance control between printings every time a predetermined number of ejections have been made since the last wiping. Graphs g2 and g4 show the detected torque recorded by the controller 40 during the dry maintenance control.

During the dry maintenance control, the ejection operation of the head 21 is not performed. In the dry maintenance control, one or more predetermined number of strokes of wiping is performed, with wiping one way in the X direction regarded as one stroke of wiping. The upper end points of the graphs g2 and g4 are the detected torques at the start of the dry wiping. The lower end points of the graphs g2 and g4 are the detected torques at the end of the dry wiping. As the wiping progresses, the wiping resistance decreases. As a result of the above, the graphs g2 and g4 are line segments parallel to the vertical axis.

Graphs g1 and g3 are line segments each connecting the start point of the wiping and the end point of the previous wiping, and each correspond to an estimated torque value against number of ejections that would be detected if the dry wiping were to start. As the number of ejections increases, the estimated torque value increases because the amount of ink that adheres to and deposits on the nozzle surface 27b increases.

### (Control Flow 1 (Dry Wiping))

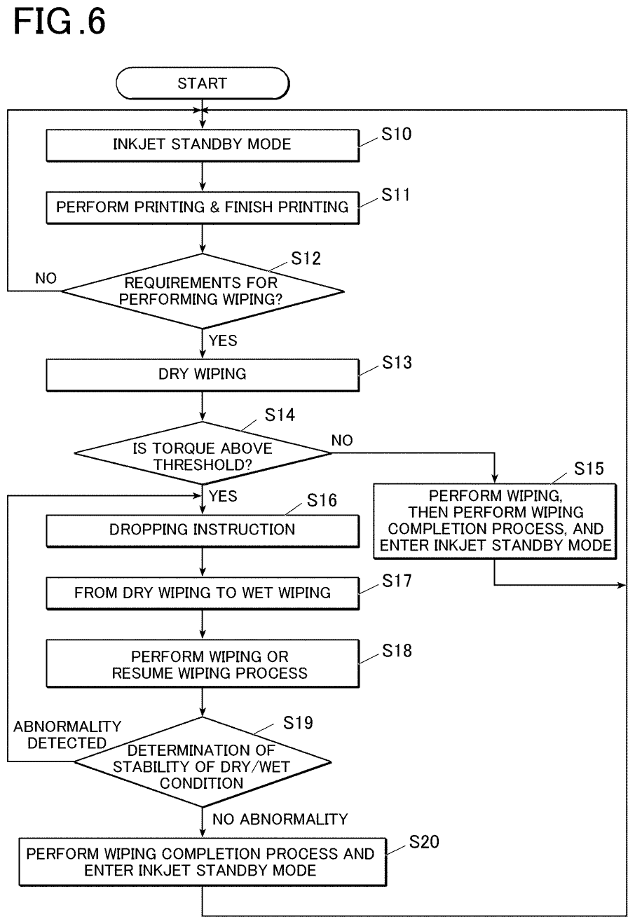

The following is a description after the controller 40 starts dry wiping control. This corresponds to a step in which dry wiping step S13 is performed after steps S10 and S11, and YES is selected in step S12 in the flowchart in FIG. 6. The condition for determining to be YES in step S12 is that the number of ejections has exceeded a predetermined number after the last wiping maintenance.

If the dry wiping is completed without the detection torque becoming equal to or greater than an abnormality threshold Ta (NO in step S14), as the wiping completion process S15, the wiping and cleaning mechanism 31 is placed at a predetermined position (the head 21 is also placed at a predetermined position if necessary), the wiping and cleaning mechanism 31 is controlled to wind a predetermined amount of the cloth 31a, and the process proceeds to the inkjet standby mode (S10).

### (Control Flow 2 (in Abnormal Stopping During Dry Wiping))

If the detected torque exceeds the abnormality threshold Ta after moving to step S13, the dry maintenance control is stopped abnormally. This abnormal stopping may be controlled by the controller 40 based on the detected torque, or may be controlled by other control systems.

The controller 40 records the detected torque at the time of stopping. This detected torque corresponds to the upper end of the graph g6 in FIG. 5.

Then, YES is selected in step S14, and the controller 40 performs the dropping instruction to the user or the liquid supplier 32 as described above (S16).

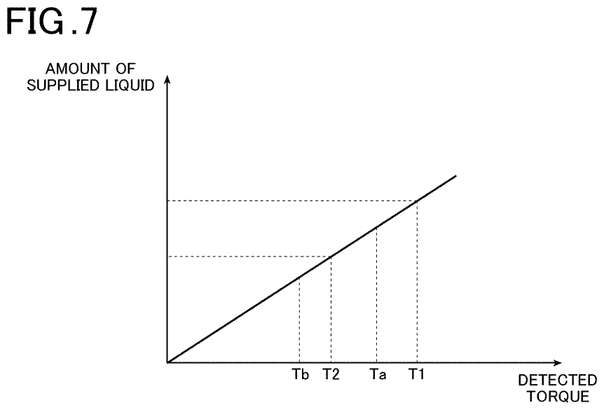

In step S16, the controller 40 performs the control to change the amount of the liquid supplied to the part of the cloth 31a to be wet according to the detected torque (index value of wiping resistance) as shown in FIG. 7. In this case, the detected torque T1 that is above the abnormality threshold Ta is recorded, and the larger the detected torque T1 is, the more amount of the liquid is controlled to be supplied. The controller 40 provides instructions to the user by specifying the number and quantity of droplets, and controls the amount of droplets to be dropped by the liquid supplier 32.

As described above, the controller 40 makes the cloth 31a wet (S17).

The controller 40 starts performing the wet wiping as a continuation of the dry wiping that was interrupted by the abnormal stopping (wiping resume process S18). This wet wiping corresponds to graph g6 in FIG. 5, and torque is also detected and recorded. Graph g7 indicates an estimated line after completion of this wet wiping.

In this wiping resume process S18, the controller 40 wipes the nozzle surface 27b by limiting the wiping range to a wiping portion where the abnormal stopping occurred in the dry maintenance control, a vicinity portion behind the wiping portion in the wiping direction, and a portion that has not been wiped due to the abnormal stopping. For example, in FIG. 4, when wiping in the direction of arrow 27c stops at the ejection port 27a1, the range 27d is defined as the wiping range for the wet wiping. The position information for this is based on the position coordinate information from the wiping position detector 33 at the time of abnormal stopping.

Not only the stop position but also the vicinity 27d1 behind the wiping direction is included because there is a possibility that the adhered ink that has caused the abnormal torque remains.

The portion that has not been wiped due to the abnormal stopping is included because the wiping has been stopped without completing the scheduled wiping. The portion that has not been wiped refers to a portion where the scheduled number of strokes of the dry wiping has not been completed and not necessarily a portion where not even one stroke of the dry wiping has been performed.

On the other hand, the controller 40 may back to the wiping start position and control the wet wiping to be performed by all strokes, without limiting the range based on the abnormally stopped position as described above (S18).

In the wet maintenance control described above, the controller 40 may control the nozzle surface 27b to be wiped only in a portion where the detected torque (index value of wiping resistance) during the dry wiping has been higher than a predetermined value. This is for efficient cleaning. For example, if the detected torque has been obtained for one stroke or part of a stroke in the last dry maintenance control, the wiping area is limited considering the detected torque in the range where it has been obtained. The detected torque obtained in the past dry maintenance control including the previous two times may be considered. This is because ink may have accumulated locally.

When the wet wiping (S18) is completed, the controller 40 places the wiping and cleaning mechanism 31 in a predetermined position (the head 21 is also placed in a predetermined position if necessary) as the wiping completion process S20, and controls the wiping and cleaning mechanism 31 to wind up a predetermined amount of the cloth 31a.

At this time, the controller 40 will wind up a larger amount of the cloth 31a to renew the part of the cloth that touches the nozzle surface 27b after the wet maintenance control is executed (the winding amount at S20) than the amount of the cloth 31a to renew the part of the cloth that touches the nozzle surface 27b after the dry maintenance control is executed (the winding amount at S15).

At this time, the controller 40 causes the winding amount of the cloth 31a to renew the part of the cloth that touches the nozzle surface 27b after the wet maintenance control is executed (the winding amount at S20) to be larger than the winding amount of the cloth 31a to renew the part of the cloth that touches the nozzle surface 27b after the dry maintenance control is executed (the winding amount at S15). This is because in the wet maintenance control, the liquid dropped on the cloth 31a and the wiped ink tend to spread the dirt over a larger area than in the dry wiping.

After the wet maintenance control (S18), the controller 40 does not perform any recording operation until the dry/wet condition of the inkjet head 21 is stabilized, that is, the controller 40 determines the stability of the dry/wet condition and then shifts to the inkjet standby mode (S10).

In a water-based inkjet machine, when the nozzle surface 27b is cleaned with the wet wipe, the cleaning liquid may remain on the nozzle surface 27b and affect the printing quality. Therefore, after cleaning the nozzle surface 27b in a wet condition, printing operation is controlled so as not to be performed until the cleaning liquid on the nozzle surface 27b is dried.

In this case, the controller 40 determines that the dry/wet condition of the inkjet head 21 has stabilized based on the elapsed time after the wetted part of the cloth 31a has been wetted. This is for the purpose of waiting for drying. Specifically, the controller 40 determines it based on the time of the drop completion input by the user or the time of the drop operation by the wiping and cleaning mechanism 31.

In addition, the controller 40 changes the determination threshold of the elapsed time depending on temperature and humidity of the environment input from the thermohygrometer 91. For example, the elapsed time is set longer in a humid environment as follows. When the environmental humidity is less than 20%, the elapsed time for drying is set to be 1.0 second; when the environmental humidity is 20% or more and less than 50%, the elapsed time for drying is set to be 2.0 seconds; when the environmental humidity is 50% or more and less than 80%, the elapsed time for drying is set to be 3.0 seconds; when the environmental humidity is 80% or more, the elapsed time for drying is set to be 4.0 seconds. The elapsed time for drying may be set in detail depending on combined conditions of the environmental temperature and the environmental humidity. Also, it will be even better when the elapsed time for drying is set longer depending on the amount of supplied liquid that has been increased or decreased due to the detected torque described above, such that the elapsed time for drying is longer when the amount of supplied liquid is larger.

On the other hand, the controller 40 may determine that the dry/wet condition of the inkjet head 21 has been stabilized based on the thermohygrometer 92, which is in the vicinity of the inkjet head 21.

As described above, when the dry maintenance control has stopped abnormally, the controller 40 does not proceed to the control of the recording operation but proceeds to the wet maintenance control.

Also, as described above, the controller 40 determines whether or not to perform the wet maintenance control based on the situation of the dry wiping in the dry maintenance control.

(Control Flow 3 (Dealing with Abnormalities During Wet Wiping))

When the controller 40 detects an abnormality in the wet maintenance control, such as detecting a torque above the abnormality threshold Ta (abnormality detected in step S19), the wet maintenance control may be repeated several times. After a predetermined number of re-drops and wet wipes are repeated, which is not shown in the drawing, an error may be notified and the control may be stopped.

### (Control Flow 4 (Predictive Control))

As shown in FIG. 5, based on the slope(s) of the estimated line of the graph(s) g1, g3, and the like, it is possible to estimate a predicted line as the graph g5.

The controller 40 performs prediction calculation for this and also sets the allowable threshold Tb.

Based on the history data (g2, g4) of the detected torque (index value of the wiping resistance) shown in FIG. 5 and the number of ejection (amount of recording operation) of the inkjet head 21, the controller 40 calculates a predicted index value of the wiping resistance of dry wiping (graph g5) on an assumption of proceeding to the dry maintenance control.

When the predicted value exceeds the predetermined allowable threshold Tb, the controller 40 performs the wet maintenance control as the next wiping control applying the wiping and cleaning mechanism 31.

In other words, the controller 40 performs the dry maintenance control when the predicted torque value corresponding to the number of ejection is less than the allowable threshold Tb on the graph g5 when the condition to perform the dry maintenance control arrives (YES in S12). However, the controller 40 does not perform the dry maintenance control but performs the dry maintenance control when the predicted torque value corresponding to the number of ejection is equal to or more than the allowable threshold Tb on the graph g5 when the condition to perform the dry maintenance control arrives (YES in S12). This wet wiping corresponds to graph g8 in FIG. 5, where torque is also detected and recorded. Graph g9 indicates an estimated line after this wet wiping is completed.

When this prediction control is used, in step S14, it is determined whether or not the predicted torque value is above the allowable threshold Tb before wiping is performed. If NO in step S14, the dry wiping is performed and then a completion process (S15). If YES in step S14, the processes after the drop instruction (S17 to S20) are performed.

Also in this predictive control, the control of the amount of supplied liquid is preferably performed according to the rules explained in FIG. 7. In this case, the amount of supplied liquid corresponds to the detected torque T2, which is above the allowable threshold Tb and below the abnormal threshold Ta.

In the wet maintenance control by this predictive control, the controller 40 may control the nozzle surface 27b to be wiped only in the portion where the detected torque (index value of wiping resistance) during the dry wiping has been higher than a predetermined value. This is for the purpose of efficient cleaning. For example, the detected torque obtained in the past dry maintenance control including the last one is considered. This is because ink may have accumulated locally.

The process of waiting for the drying is also carried out in the same way.

In step S18 in this prediction control, since it is not in the middle of the dry wiping, not the wiping resume process but the wet wiping from the wiping start position by all strokes is performed.

With this predictive control, it is possible to avoid abnormal stopping of the wiping operation, recognize the need for the wet wiping in advance, and efficiently restore the clean state of the nozzle surface 27b. Because abnormal stopping can be avoided, damage and deterioration of the apparatus can be suppressed.

In this predictive control, even when the above-mentioned predicted torque is less than the allowable threshold Tb and the dry maintenance control is performed, the torque is just a predicted value. Therefore, when the process actually proceeds to the dry maintenance control, the torque of the wiping drive may be above the abnormal threshold Ta. In that case, the process can be shifted to the control flow 2 described above. Therefore, this predictive control (Control Flow 4) and the above Control Flow 2 may be performed in combination.

As described above, the controller 40 determines whether or not to perform wet maintenance control, based on the situation of the dry wiping in the dry maintenance control, and also based on the above predictive calculation in the case of the control flow 3.

### [Effects and Others]

According to the inkjet recording apparatus 1 of the embodiment described above, it is possible to avoid increasing the size of the inkjet recording apparatus 1 having a cleaning mechanism 31 for dry wiping the nozzle surface 27b of the inkjet head 21, while effectively cleaning the nozzle surface 27b and recovering the ink ejection performance by performing wet wiping on a required part when necessary.

In other words, since the wiping and cleaning mechanism 31 applied to the dry wiping is also used in the wet wiping, it is possible to avoid increasing the size of the apparatus 1.

When the cloth 31a is wetted by the user with a dropper or the like, it is not necessary to have a device to supply liquid to the cloth 31a, and it is possible to avoid increasing the size of the apparatus 1.

Because the cloth 31a is wetted only partly around the portion that comes into contact with the ejection port 27a of the nozzle, not the entire area thereof, the wetting work can be done efficiently, and even when a liquid supplier 32 is used, only a small liquid supplier 32 is needed. Therefore, it is possible to avoid increasing the size of the apparatus 1.

In addition, since whether or not to perform the wet maintenance control is determined based on the situation in the dry wiping, it is possible to identify the situation in which wet wiping is necessary, and since unnecessary wet wiping is not performed, the operation can be made more efficient. At the same time, even when the liquid supplier 32 is used, only a small liquid supplier 32 with a small tank capacity can be used. Therefore, it is possible to avoid increasing the size of the apparatus 1.

In addition, since the control to change the amount of liquid droplets and the control to limit the wiping position are performed during the wet wiping, efficient and effective wet wiping can be realized. Since the liquid for wet wiping is efficiently used, the amount of supplied liquid is suppressed, thereby reducing the burden and time required for liquid supply. Also, even when a liquid supplier 32 is used, only a small liquid supplier 32 is needed. Therefore, it is possible to avoid increasing the size of the apparatus 1.

In addition, after the wet maintenance control is performed, the recording operation is not performed until the dry/wet condition of the inkjet head is stabilized. As a result, recording performance can be maintained at a high level and the liquid for the wet wiping is minimized so that the cleaning effect can be maximally efficient. Therefore, it is also possible to suppress the prolongation of the waiting time until the dry/wet condition of the inkjet head is stabilized.

In addition, because the cloth 31a is wetted only partly around the part that comes into contact with the ejection port 27a of the nozzle, not the entire area thereof, the liquid for the wet wiping is minimized so that the maximum efficient cleaning effect can be obtained. Therefore, the wetted parts (total wetted area) of the cloth 31a can be suppressed, so that the dry part can be secured sufficiently. Then, the dry wiping can be continued without trouble. (It is easy to keep the unused part of the roll from getting wet.)

In the above embodiment, the index value of the wiping resistance during the dry wiping is the magnitude of the driving force in the dry wiping, but it may be calculated by the controller 40 based on the positional coordinate information in the wiping direction X of the cloth 31a. By obtaining time-series data of the positional coordinate information during wiping, the controller 40 can calculate an instantaneous wiping rate at each coordinate, assuming that the slower the rate, the larger the wiping resistance, and use this as an index value of the wiping resistance. This method can be used when the drive for wiping is under a constant torque control. The controller 40 may also calculate the index value of wiping resistance by using the above magnitude of the driving force and the instantaneous wiping rate together. Other examples may be used without limitation as long as they can be used as an index value of the wiping resistance. Alternatively, in order to recognize the situation of the dry wiping, the distribution of the ink remaining on the nozzle surface 27b may be obtained instead of the index value of the wiping resistance of the dry wiping.

Although embodiments of the present invention have been described and illustrated in detail, the disclosed embodiments are made for purposes of illustration and example only and not limitation. The scope of the present invention should be interpreted by terms of the appended claims.

What is claimed is:

1. An inkjet recording apparatus comprising:
an inkjet head that ejects ink from a nozzle and records an image;
a wiping and cleaning mechanism that wipes a nozzle surface with a cleaning member, the inkjet head has the nozzle surface at which an ejection port of the nozzle of is formed; and
a hardware processor that controls operation including the recording operation; wherein
the hardware processor performs dry maintenance control in which dry wiping using the wiping and cleaning mechanism is controlled, and wet maintenance control in which wet wiping using the wiping and cleaning mechanism and including wetting at least a part of a wiping surface of the cleaning member is controlled.

2. The inkjet recording apparatus according to claim 1, wherein,
in the wet maintenance control, the hardware processor instructs a user to wet at least a part of the wiping surface of the cleaning member, and, upon at least a part of the wiping surface being wet, wipes the nozzle surface with the cleaning member in a wet condition.

3. The inkjet recording apparatus according to claim 1, wherein,
in the wet maintenance control, the hardware processor instructs a liquid supplier to wet at least a part of the wiping surface of the cleaning member, and, upon at least a part of the wiping surface being wet, wipes the nozzle surface with the cleaning member in a wet condition.

4. The inkjet recording apparatus according to claim 1, wherein
the hardware processor determines whether or not to perform the wet maintenance control based on a situation of the dry wiping in the dry maintenance control.

5. The inkjet recording apparatus according to claim 4, wherein
the hardware processor obtains an index value of wiping resistance of dry wiping in the dry maintenance control and recognizes the situation of the dry wiping.

6. The inkjet recording apparatus according to claim 5, wherein
the index value of the wiping resistance is a driving force in the dry wiping.

7. The inkjet recording apparatus according to claim 5, wherein
the hardware processor calculates the index value of the wiping resistance based on positional coordinate information of the cleaning member in a wiping direction.

8. The inkjet recording apparatus according to claim 5, wherein,
in the wet maintenance control, the hardware processor performs control including change of an amount of liquid supplied to the part depending on the index value of the wiping resistance.

9. The inkjet recording apparatus according to claim 5, wherein,
in the wet maintenance control, the hardware processor wipes the nozzle surface only at a portion where the index value of the wiping resistance is more than a predetermined value.

10. The inkjet recording apparatus according to claim 5, wherein
the hardware processor calculates a predicted index value of the wiping resistance of dry wiping based on history data of index value of the wiping resistance and an amount of recording operation of the inkjet head, the predicted index value being on an assumption of proceeding to the dry maintenance control, and
upon calculation of the predicted index value being above a predetermined allowable threshold, the hardware processor performs the wet maintenance control as a next wiping control applying the wiping and cleaning mechanism.

11. The inkjet recording apparatus according to claim 1, wherein,
upon abnormal stopping of the dry maintenance control, the hardware processor proceeds to the wet maintenance control without proceeding to control of the recording operation.

12. The inkjet recording apparatus according to claim 11, wherein,
in the wet maintenance control, the hardware processor wipes the nozzle surface only at a wiping portion where the abnormal stopping occurred in the dry maintenance control, a vicinity portion of the wiping portion behind the wiping direction, and a portion that has not been wiped due to the abnormal stopping.

13. The inkjet recording apparatus according to claim 1, wherein
the part includes a portion in contact with the ejection port of the nozzle during wiping.

14. The inkjet recording apparatus according to claim 1, wherein
the hardware processor does not start the recording operation after performing the wet maintenance control until a dry/wet condition of the inkjet head is stabilized.

15. The inkjet recording apparatus according to claim 14, wherein
the hardware processor determines that the dry/wet condition of the inkjet head is stabilized based on elapsed time after the part has been wetted.

16. The inkjet recording apparatus according to claim 15, wherein
the hardware processor changes a determination threshold of the elapsed time depending on environmental temperature and environmental humidity.

17. The inkjet recording apparatus according to claim 14, wherein
the hardware processor determines that the dry/wet condition of the inkjet head is stabilized based on temperature and humidity in a vicinity of the inkjet head.

18. The inkjet recording apparatus according to claim 1, wherein
the wiping and cleaning mechanism includes a winding mechanism that winds up the cleaning member and renews a portion of the cleaning member in contact with the nozzle surface, and
the hardware processor causes the cleaning member wound up in renewing a portion in contact with the nozzle surface to be larger after the wet maintenance control than after the dry maintenance control.
